(19) United States
(12) Patent Application Publication
(10) Pub. No.: US 2024/0046232 A1
(43) Pub. Date: Feb. 8, 2024

(54) SYSTEM AND METHOD FOR MANAGING DEBT

(71) Applicant: Troy Withers, San Antonio, TX (US)

(72) Inventor: Troy Withers, San Antonio, TX (US)

(21) Appl. No.: 18/360,219

(22) Filed: Jul. 27, 2023

Related U.S. Application Data
(60) Provisional application No. 63/396,193, filed on Aug. 8, 2022.

(51) Int. Cl. G06Q 20/10; G06Q 40/03

(52) U.S. Cl. CPC G06Q 20/108; G06Q 40/03

(57) ABSTRACT

A system and method for debt management in auto loans that facilitate recovery of debt loans from customers who fail to repay the whole debt as per the contract. A customer defaulting on an auto loan can be provided incentives for providing ASE certified inspection report for the vehicle held as collateral with photographs of the vehicle, and the same can be presented by the system to dealers interested in purchasing the vehicle. The proceeds of the sale are used to settle the balance debt. The system also facilitates another small loan to the customer for an affordable vehicle. The system also facilitates the customer and bank to reach an agreement to further settle any remaining debt balance.

### CROSS-REFERENCE TO RELATED APPLICATIONS

This application claims priority from a U.S. Provisional patent Appl. No. 63/396,193 filed on Aug. 8, 2022, the content of which is incorporated herein by reference in its entirety.

### FIELD OF INVENTION

The present invention relates to a system and method for financial management, and more particularly, the present invention relates to a system and method of auto loan debt recovery.

### BACKGROUND

Auto loan defaults have been a major problem in the retail banking customer lending industry. Default occurs when the customer fails to make a required payment on the loan as per the pre-agreed contract. When a customer goes past due on an auto loan, the lender attempts to collect on that loan and sends notifications to the customer. Such notifications can include written letters and a Right to Cure letter which states that the customer has X number of days (based on state law) to bring the account current before the loan is reviewed for repossession. If the customer still fails to make the required repayments, then the account is reviewed for and assigned to a repossession company.

The role of the repossession company is to find and retrieve the debtor's collateral item, which is an automobile for which the auto loan was taken. The repossession company, upon finding the automobile, repossesses it and brings it to a repossession lot. The customer now must make the repayments for the balance debt as well as pay the repossession fees. The lender notifies the customer that they have X days (based on state law) to bring the account current plus pay the repossession charges to get the secured collateral back.

In case the customer pays the balance debt, the repossession fees, and other charges, then the lender allows the repossessed car to be released back to the customer. However, in case the customer fails to pay the amount due, then the vehicle is sold at auctions. Auctions can take place from the repossession lot, a physical auction, or an online auction. In an auction, the collateral is sold to the highest bidder (dealer) and the amount obtained upon auction is applied to the outstanding balance owed to the lender.

The lender typically adds the repossession and auction fees to the deficiency balance which is still owed by the customers. That deficiency balance is then collected from the lender, a deficiency collection agency, or litigation attorney, or the debt is sold to a debt buyer.

Thus, the above process has many drawbacks and has been used for decades by creditors to offset their potential losses. Also, many times, the customer and the bank may have reached another agreement after repossession. However, the company may fail to return the repossessed vehicle after borrowers completed the agreement. Moreover, in many scenarios, the customers can hide the cars since they need them for their livelihood.

A need is therefore appreciated for a system and method that overcomes the drawbacks of the existing system for recovering loans and repossession of collaterals.

The term hereinafter refers to automobiles, spacecraft, watercraft, and the like. The automobiles include land vehicles including two-wheelers, three-wheelers, and four-wheelers.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method for auto loan management in case of default in repayment.

It is another object of the present invention that the process of repossession and auction can be prevented.

It is still another object of the present invention that the system can save the customers from any embarrassment due to the recovery process.

It is yet another object of the present invention that the rate of non-payments can be reduced.

It is a further object of the present invention that the bank expenditure in the loan recovery can be significantly reduced.

In one aspect, disclosed are a system and method for debt management in auto loans that facilitate recovery of debt loans from customers who fail to repay the whole debt as per the contract. A customer defaulting on an auto loan can be provided incentives for providing ASE certified inspection report for the vehicle held as collateral with photographs of the vehicle, and the same can be presented by the system to dealers interested in purchasing the vehicle. The proceeds of the sale are used to settle the balance debt. The system also facilitates another small loan to the customer for an affordable vehicle. The system also facilitates the customer and bank to reach an agreement to further settle any remaining debt balance.

In one aspect, disclosed is a system for debt management, the system comprising a processor and a memory, the system configured to implement a method comprising receiving, from a customer interface, ASE-certified inspection report and photographs of a vehicle held collateral in an auto loan; presenting, on a plurality of dealer interface, the ASE-certified inspection report and photographs of the vehicle; receiving, through a dealer interface of the plurality of dealer interface, a purchase request of the vehicle; receiving, through the dealer interface, proceeds of a sale of the vehicle from the dealer device interface; and using the proceeds of the sale to settle a debt balance. The system is further configured to implement the method comprising facilitating incentives for providing the ASE-certified inspection report and the photographs. The system is further configured to implement the method comprising facilitating interaction between a lender interface and the customer interface for a second loan.

### BRIEF DESCRIPTION OF THE DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is a schematic diagram showing an embodiment of the present invention.

FIG. 2 is a block diagram showing an environment of the system, according to an exemplary embodiment of the present invention.

FIG. 3 is a block diagram showing an architecture of the system, according to an exemplary embodiment of the present invention.

### DETAILED DESCRIPTION

The subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, reasonably broad scope for claimed or covered subject matter is intended. Among other things, for example, the subject matter may be embodied as system and methods of use thereof. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting to embodiments of the invention. As used herein, the singular forms “a”, “an”, and “the” are intended to include the plural forms as well, unless the context indicates otherwise. It will be further understood that the terms “comprise”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

In the following description, for purposes of explanation, specific details may be set forth in order to provide a thorough understanding of the subject innovation. It may be evident, however, that the claimed subject matter may be practiced without these specific details. In other instances, well-known structures and systems are shown in block diagram form to facilitate describing the subject innovation.

Disclosed are a system and method for managing debts, in particular auto loans. The disclosed system and method aim at making the process of loan recovery easier and more efficient when the customer cannot make the repayments. The disclosed system and method tend to make a favorable situation for both the debtors and creditors in case of defaults in repayments by the debtors. The disclosed system and method overcome the drawbacks in existing processes including the repossession and auction of collaterals. The additional charges incurred due to involving the repossession companies and conducting the auctions can be saved.

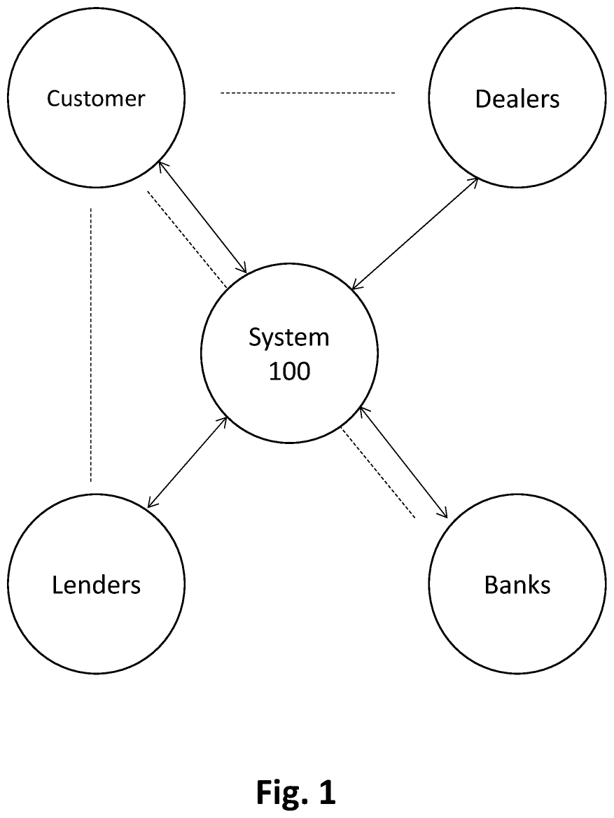

The disclosed system and method can create a network that connects the customer with the dealers, lenders, and banks. The network allows the process of recovering the debt balance by the bank and allows the customer to get a more affordable vehicle. FIG. 1 illustrates a hub of a multi-spoke process that links the customers with dealers, their banks, and lenders.

A customer who has taken an auto loan but could not repay the same due to any of a variety of reasons can use the disclosed system. First, the bank, through the disclosed system, can pay the customer to get an ASE-certified inspection of the collateral and to include pictures of the collateral. The certified report and the pictures may allow any person to judge the condition of the collateral to decide for purchasing the collateral. In the absence of such information i.e., reports and pictures, the bids are generally low as the bidders are uncertain about the condition of the vehicle. Thus, the bank may offer certain incentives to the customer to use this process.

Once the inspection reports and the pictures can be received by the system from the customer, the system can connect the customer with the nationwide dealer network for purchasing the vehicle. The system may facilitate the sale of the vehicle by the customer to the dealer. The system can allow dealers to purchase the vehicles directly and indirectly. The dealers can be presented with a dealer interface by the disclosed system. The dealer interface can show the report and pictures to the dealer. The system may track the whole process and can keep the bank and the dealer informed about the same. The interface can also allow the dealer to make the payment upon making the purchase, and the disclosed system can route the proceeds of the sale to the bank ensuring that the proceeds are applied to the balance.

Thereafter, the disclosed system can connect the customer with a network of sub-prime lenders. The system may facilitate another loan to the customer by the sub-lenders that may allow the customer to have another affordable vehicle. Chances are that the customer's credit is not in great shape at this point. However, the disclosed system may facilitate the loan that best suits the status of the customer. This may ensure that the customer still has a vehicle for their daily needs.

The system can then facilitate the customer and the primary bank to work together to settle the difference between the sale proceeds and the debt balance. Presently, the banks send the deficiency balance to a collection agency and pay a 20-25% contingency fee. The disclosed system can help save the same by facilitating the difference and reaching a settlement. Revenue can be generated by the system on a per-use fee basis or licensing fee paid by the banks. With the ASE certification, incentive, and license fee, the banks can reduce their costs by roughly 50% while providing a significantly better customer experience.

The disclosed system and method eliminate the repossession companies and auctions and allow the customer to work directly with the dealer. The bank would provide an incentive to the customer to go through the dealer model and pay for an ASE Certified Inspection. The biggest challenge for a dealer when purchasing collateral at an auction is that they are not fully aware of the condition of the collateral. Providing an ASE-certified inspection gives the dealer comfort in knowing what it is that they are purchasing. This should provide a higher valuation of the collateral and give the customer more money for the collateral. The dealer then works with the customer to sell them a car that they can afford which means that the customer wins since they still have a car in their driveway/parking lot. The bank wins since they save significant fees for repossession and auction while recovering more money to apply to the outstanding balance on the loan. The disclosed system may allow the customer to set up a payment plan to pay the deficiency balance or settle the deficiency balance over time. This avoids the loan being assigned to a deficiency collection agency.

The disclosed system and method provide a better approach to resolving a debt that is beneficial for both sides i.e., the creditor and debtor. The customer avoids the embarrassment of the repossession, saves on the repossession fees and auction fees, reduces the deficiency balance, can automatically schedule payment arrangements, or settle the deficiency balance, and importantly the customer is in control. The bank provides an incentive to the customer and still saves millions of dollars in repossession and auction fees, satisfies regulatory requirements by eliminating risks, demonstrates the ability to work with customers, increases overall recovery rates, and saves on contingency fees with deficiency collection agencies.

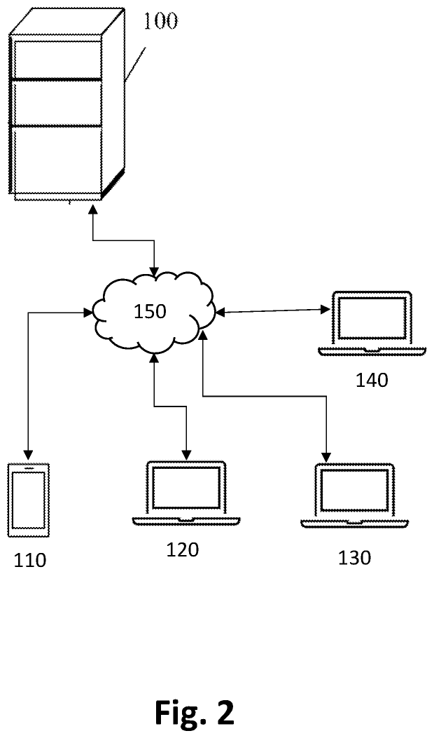

Referring to FIG. 2 which is a block diagram showing an environment of the disclosed system 100. System 100 can connect to a customer device 110, a bank device 120, a dealer device 130, and a lender device 140. The said devices can be personal computing devices, a smartphone, a tablet computer, a workstation, a laptop, and the like. The different devices can connect with the disclosed system through a network 150, wherein the network can be a wireless network, a wired network, or a combination of a wired network and a wireless network. Examples of networks include a local area network (LAN), a wide area network (WAN), a wireless WAN, a wireless LAN (WLAN), a metropolitan area network (MAN), a wireless MAN network, a cellular data network, a cellular voice network, the Internet, etc. Also, FIG. 2 shows different devices connected with the disclosed system through a single network for illustration only, different devices can connect with the disclosed system through different networks. Moreover, a single device may connect with the disclosed system through more than one network, for example, a customer device can connect with the disclosed system through a wireless network and a wired network.

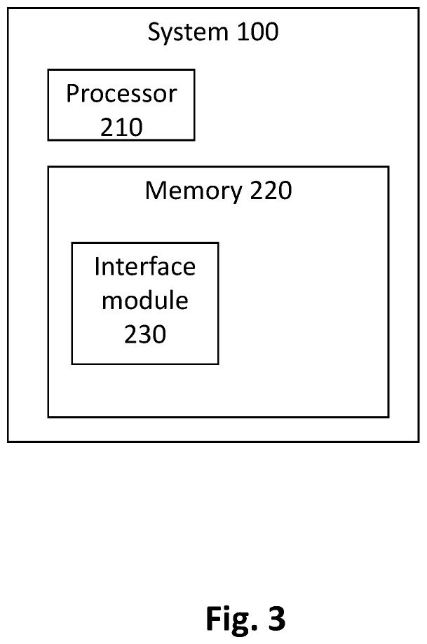

Referring to FIG. 3 which is a block diagram showing an architecture of the disclosed system 100. The system 100 includes a processor 210 and a memory 220. The processor can be any logic circuitry that responds to, and processes instructions fetched from the memory. The memory may include one or more memory chips capable of storing data and allowing any storage location to be directly accessed by the processor. The memory includes modules according to the present invention for execution by the processor to perform one or more steps of the disclosed methodology.

The disclosed system can at least include interface module 230 that provides interfaces on the customer device, bank device, dealer device, and a lender device, commonly referred to herein as a user device. The interface can be provided as application software that can be installed on the user device. The application software can be developed for Android™, iOS, and any other known operating platform for mobile devices. The application software can be made available through a distribution service provider, for example, Google Play™ operated and developed by Google, and the app store by Apple. In addition to the application software, a website-based interface can also be provided through the world-wide-web. The application software can also be provided for the desktop environment, such as Windows™, Linux, and macOS. The user interface may permit interaction with a user through the user device, wherein information can be presented within the user interface by system 100 and information can be received by system 100 from the user.

It is to be understood that the disclosed system and method can incorporate any of the technologies related to Blockchain, Smart Contracts, and the Internet of Things without departing from the scope of the present invention. For example, blockchain technology can add trust to the transactions and prevent any falsification. The smart contract can fasten the process and add more transparency to the transactions. Moreover, said technology can be used to gather information on the collateral through vehicle telematics which could at some point replace the ASE certification.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A system for debt management, the system comprising a processor and a memory, the system configured to implement a method comprising:
receiving, from a customer interface, ASE-certified inspection report and photographs of a vehicle held collateral in an auto loan;
presenting, on a plurality of dealer interface, the ASE-certified inspection report and photographs of the vehicle;
receiving, through a dealer interface of the plurality of dealer interface, a purchase request of the vehicle;
receiving, through the dealer interface, proceeds of a sale of the vehicle from the dealer interface;
using the proceeds of the sale to settle a debt balance.

2. The system of claim 1, wherein the system is further configured to implement the method comprising:
facilitating incentives for providing the ASE-certified inspection report and the photographs.

3. The system of claim 1, wherein the system is further configured to implement the method comprising:
facilitating interaction between a lender interface and the customer interface for a second loan.

4. A method for debt management, the method implemented within a system comprising a processor and a memory, the method comprising:
receiving, from a customer interface, ASE-certified inspection report and photographs of a vehicle held collateral in an auto loan;
presenting, on a plurality of dealer interface, the ASE-certified inspection report and photographs of the vehicle;
receiving, through a dealer interface of the plurality of dealer interface, a purchase request of the vehicle;
receiving, through the dealer interface, proceeds of a sale of the vehicle from the dealer interface;
using the proceeds of the sale to settle a debt balance.

5. The method of claim 4, wherein the system is further configured to implement the method comprising:
facilitating incentives for providing the ASE-certified inspection report and the photographs.

6. The method of claim 4, wherein the system is further configured to implement the method comprising:
facilitating interaction between a lender interface and the customer interface for a second loan.
